(19) United States
(12) Patent Application Publication
(10) Pub. No.: US 2007/0215444 A1
(43) Pub. Date: Sep. 20, 2007

(54) Power Supply Apparatus

(76) Inventors: Ryoji Ehara, Odawara-shi (JP); Akinori Kagawa, Odawara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/597,912

(22) PCT Filed: Jun. 1, 2005
(86) PCT No.: PCT/JP05/10033

§ 371 Date: Nov. 29, 2006

(30) Foreign Application Priority Data
Jun. 4, 2004 (JP) 2004-166784

(51) Int. Cl. F02N 11/08

(52) U.S. Cl. 200/82 DA

(57) ABSTRACT

A power supply apparatus of an engine electrical system reliably starts the engine even in a battery-less apparatus or in a condition that the battery is completely discharged.

The power generated in an AC generator 11 is supplied to a power supply line L via a regulator 12. The power supply line L is connected to a capacitor 13 and electronic control unit (ECU) 14. A fuel injection system (FI system) 15 is connected to the power supply line L1 via a first switch 17. The electronic control unit 14 monitors the voltage of the power supply line L1. In kick starting, the first switch 17 is set at OFF, and turned ON when the measured voltage is a reference voltage value or more.

### TECHNICAL FIELD

The present invention relates to a power supply apparatus of an engine electrical system, and more particularly, to a power supply apparatus of a two-wheeled motor vehicle using a generator.

### BACKGROUND ART

In a battery-less fuel injection system without a battery, for example, a configuration provided with a capacitor is known to drive the fuel injection system (see Patent Document 1). Further, another configuration is known where in starting an engine of a two-wheeled motor vehicle or the like, electrical loads except the fuel injection system are disconnected from a power supply line, thereby reducing the electrical loads in startup and improving engine startup characteristics (see Patent Document 2).
Patent Document 1: JP 2002-98032
Patent Document 2: JP H09-324732

### DISCLOSURE OF INVENTION

Problems to be Solved by the Invention

In a battery-less two-wheeled motor vehicle or in a condition that a battery is completely discharged, the engine is started by kicking, and to start the engine, it is necessary to increase the peak voltage of the power supply to at least more than a minimum voltage required to activate the fuel injection system. Accordingly, when the kicking force is weak in kick starting, the peak voltage does not reach the minimum voltage, and the engine cannot be started. Meanwhile, the fuel injection system consumes the power even when not activated. Therefore, when the kicking force is weak and the engine is not started, the electrical energy temporarily stored in the capacity by kicking is immediately consumed, and a problem arises that the engine is not started even by repeating kicking a plurality of times. In particular, when a large-capacitance capacitor is used to suppress a reduction in power supply voltage by electrical loads that are activated after the engine is started, the power absorbed by the capacitor becomes large in kick starting, and a strong kicking force is required for the peak voltage of the power supply to reach the minimum voltage.

It is an object of the invention to provide a power supply apparatus of an engine electrical system enabling the engine to be started reliably even in a battery-less apparatus or in a condition that the battery is completely discharged.

Means for Solving the Problem

A power supply apparatus of the invention has an AC generator, a fuel injection system, a power supply line that supplies power generated in the AC generator to the fuel injection system, a capacitor that suppresses fluctuations in voltage of the power supply line, and power supply suppressing means for suppressing a power supply amount from the power supply line to the fuel injection system in kick starting.

For example, the power supply suppressing means controls ON/OFF of a switch provided on the power supply line to control suppression of the power supply amount. Further, for example, the power supply suppressing means turns an actuator of idle speed control OFF to suppress power consumption in a power saving mode.

Further, the power supply suppressing means preferably has voltage measuring means for measuring the voltage of the power supply line, and it is preferable that suppression of the power supply suppressing means is canceled based on the measured voltage. Furthermore, for example, the power supply suppressing means has a dedicated power supply different from the power supply line.

### ADVANTAGEOUS EFFECT OF THE INVENTION

As described above, according to the invention, it is possible to provide a power supply apparatus of an engine electrical system enabling the engine to be started reliably even in a battery-less apparatus or in a condition that the battery is completely discharged.

### BEST MODE FOR CARRYING OUT THE INVENTION

Embodiments of the present invention will specifically be described below with reference to accompanying drawings.

FIG. 1 is a block diagram schematically illustrating an electrical configuration of a power supply system in a battery-less two-wheeled motor vehicle that is a first embodiment of the invention.

A power supply apparatus 10 of a two-wheeled motor vehicle of this embodiment is generally comprised of, for example, an AC generator (ACG) 11, regulator (Reg) 12, capacitor 13, electronic control unit (ECU) 14, fuel injection system (FI system) 15, DC loads 16 comprised of direction indicators, stop lamps, horn and the like except the fuel injection system 15, first switch 17 and second switch 18.

The power generated in the AC generator 11 is supplied to each electrical system including the fuel injection system 15 via the regulator 12. The first switch 17 is provided on a power supply line L to supply the power to each electrical system from the regulator 12, and the capacitor 13 and electronic control unit 14 are connected to the power supply line L1 on the generator side from the first switch 17.

Meanwhile, the power supply line L2 on the opposite side to the first switch 17 is connected to the fuel injection system 15 and DC loads 16. In other words, when the first switch is OFF, the capacitor 13 and electronic control unit 14 are electrically connected to the AC generator 11, while the fuel injection system 15 and DC loads 16 are electrically disconnected from the AC generator 11. Further, the DC loads 16 are connected to the power supply line L2 via the second switch 18, and when the second switch 18 is OFF, the DC loads 16 are electrically disconnected from the power supply line L2.

ON/OFF of the first switch 17 is switched and controlled by the electronic control unit 14. The electronic control unit 14 first determines the first switch 17 to be OFF, monitors the voltage of the power supply line L1, and when the voltage of the power supply line L1 reaches a reference voltage value (for example, minimum voltage value required for the voltage of the power supply to activate the fuel injection system), switches the first switch 17 ON.

In other words, all the power generated by kicking is stored in the capacitor 13 until the first switch 17 is turned ON. Based on the generated power from the AC generator 11 by kicking and the power stored in the capacitor 13, when the voltage of the power supply line L1 exceeds the reference voltage value, the first switch 17 is turned ON, and the fuel injection system 15 is activated. In addition, in starting the engine, the second switch 18 is determined to be OFF, and switched ON after the engine is started. For example, ON/OFF control of the second switch 18 is performed by the electronic control unit 14.

As described above, according to the first embodiment, even in a kicking force of a level of not starting the engine, the generated power by the kicking force can be stored in the capacitor, and by repeating the kicking twice or more, it is possible to start the engine reliably if the kicking force is weak, thereby improving the engine startup performance.

Further, since the first switch is provided, it is possible to reduce loads electrically connected to the generator in kick starting, and the kicking force can be lightened. By this means, the startup characteristic is further improved.

A power supply apparatus of a second embodiment of the invention will be described below with reference to FIG. 2. FIG. 2 is a block diagram schematically illustrating an electrical configuration of a power supply system in a battery-less two-wheeled motor vehicle that is the second embodiment. In addition, the configuration of the second embodiment is substantially similar to that of the first embodiment, and the same components as in the first embodiment are assigned the same reference numerals to omit descriptions thereof.

A power supply apparatus 20 of the second embodiment differs from the power supply apparatus 10 of the first embodiment in a respect that the electronic control unit 14 in the first embodiment is supplied with the power from a dedicated power supply (battery 19). Since the electronic control unit 14 has less power consumption than power consumption of the fuel injection system 15, although it is possible to directly supply the power from the power supply line L1 as in the first embodiment, by supplying the power from the dedicated power supply as in the second embodiment, it is possible to make charging of the capacitor 13 more reliable, and further improve the engine startup performance.

A power supply apparatus of a third embodiment of the invention will be described below with reference to FIG. 3. FIG. 3 is a block diagram schematically illustrating an electrical configuration of a power supply system in a battery-less two-wheeled motor vehicle that is the third embodiment.

A power supply apparatus 30 of the third embodiment has the configuration substantially similar to that of the power supply apparatus 20 of the second embodiment, but differs from the power supply apparatus 20 of the second embodiment in a respect that a power saving mode is provided.

In the third embodiment, after turning the second switch 18 ON, the electronic control unit 14 maintains OFF of a power supply of part of the electrical devices included in the DC loads 16 for a period until the voltage of the power supply line L is stabilized, and keeps power consumption low. As an example of the electrical device of which the power supply is kept OFF, there is an actuator (for example, stepping motor) of idle speed control (ISC) with large power consumption. In this embodiment, after the second switch 18 is turned ON, for a period until the voltage of the power supply line L is stabilized, the actuator for ISC is kept OFF, and the power supply voltage is thereby prevented from abruptly decreasing when the second switch 18 is turned ON.

In addition, as the timing at which the actuator is turned ON to cancel the saving power mode, the actuator is turned ON after starting the engine, after a lapse of predetermined time, or while monitoring the voltage of the power supply line L.

Meanwhile, when the actuator for ISC is turned OFF during the power saving mode, it is necessary to be forehand set a throttle opening at a suitable idle opening. For example, such a setting is achieved by holding the throttle opening in starting the engine in memory (not shown) of the electronic control unit 14, and when halting the engine, setting the throttle opening at the idle opening based on the value. In other words, even when the actuator for ISC is OFF, it is possible to obtain a substantially suitable idle opening in starting the engine.

As described above, substantially the same effects as in the first and second embodiments are obtained also in the third embodiment.

In addition, while this embodiment describes the battery-less system as an example, the invention is applicable to systems provided with a battery. In other words, the invention is applied to the case that the battery is completely discharged and kick starting is performed.

### BRIEF DESCRIPTION OF DRAWINGS

FIG. 1 is a block diagram schematically illustrating a configuration of a power supply apparatus of a two-wheeled motor vehicle that is the first embodiment of the invention;

FIG. 2 is a block diagram schematically illustrating a configuration of a power supply apparatus of a two-wheeled motor vehicle that is the second embodiment of the invention; and

FIG. 3 is a block diagram schematically illustrating a configuration of a power supply apparatus of a two-wheeled motor vehicle that is the third embodiment of the invention.

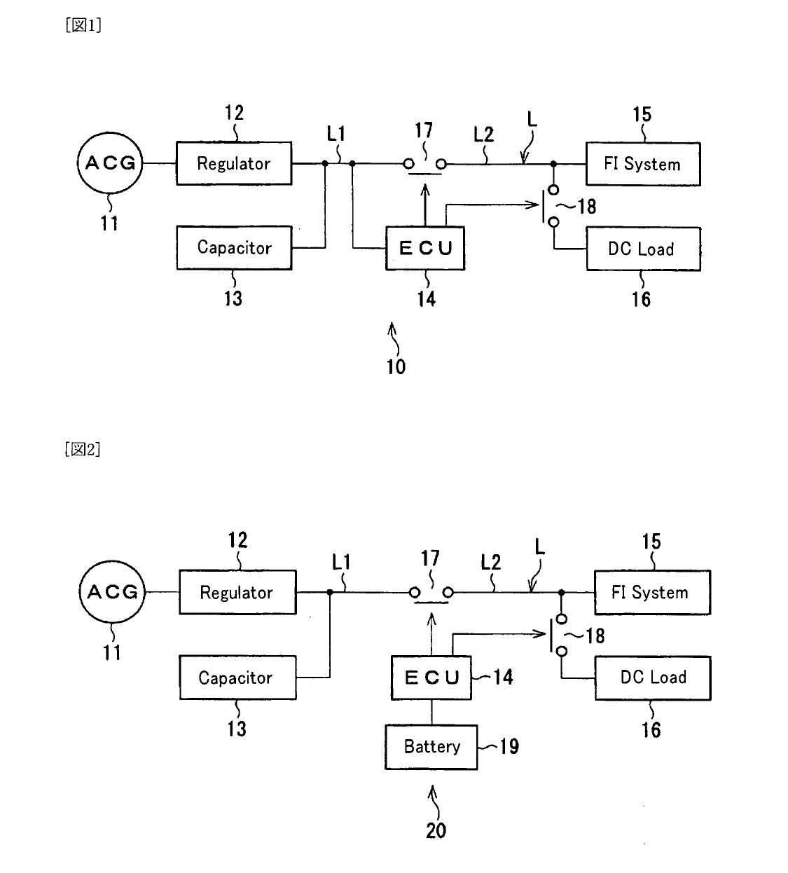

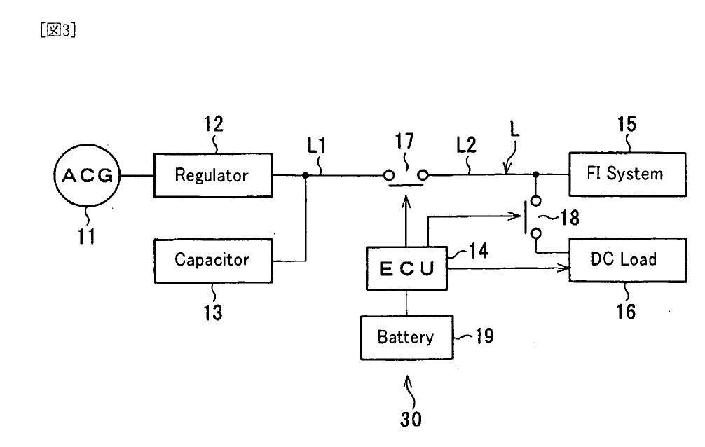

### BRIEF DESCRIPTION OF SYMBOLS

10, 20, 30 Power Supply Apparatus
11 AC Generator (ACG)
12 Regulator
13 Capacitor
14 Electronic Control Unit
15 Fuel Injection System (FI System)
16 DC Load except Fuel Injection System
17 First Switch
L, L1, L2 Power Supply Line

1. A power supply apparatus comprising:
an AC generator;
a fuel injection system;
a power supply line that supplies power generated in the AC generator to the fuel injection system;
a capacitor that suppresses fluctuations in voltage of the power supply line; and
power supply suppressing means for suppressing a power supply amount from the power supply line to the fuel injection system in kick starting.

2. The power supply apparatus according to claim 1, wherein the power supply suppressing means controls ON/OFF of a switch provided on the power supply line to control suppression of the power supply amount.

3. The power supply apparatus according to claim 1, wherein an actuator of idle speed control is turned OFF in a power saving mode corresponding to a condition of a battery after starting the engine.

4. The power supply apparatus according to claim 1, wherein the power supply suppressing means has voltage measuring means for measuring the voltage of the power supply line, and based on the measured voltage, suppression of the power supply suppressing means is canceled.

5. The power supply apparatus according to claim 1, wherein the power supply suppressing means has a dedicated power supply different from the power supply line.

6. The power supply apparatus according to claim 2, wherein the power supply suppressing means has voltage measuring means for measuring the voltage of the power supply line, and based on the measured voltage, suppression of the power supply suppressing means is canceled.

7. The power supply apparatus according to claim 3, wherein the power supply suppressing means has voltage measuring means for measuring the voltage of the power supply line, and based on the measured voltage, suppression of the power supply suppressing means is canceled.

8. The power supply apparatus according to claim 2, wherein the power supply suppressing means has a dedicated power supply different from the power supply line.

9. The power supply apparatus according to claim 3, wherein the power supply suppressing means has a dedicated power supply different from the power supply line.

10. The power supply apparatus according to claim 4, wherein the power supply suppressing means has a dedicated power supply different from the power supply line.

11. The power supply apparatus according to claim 6, wherein the power supply suppressing means has a dedicated power supply different from the power supply line.

12. The power supply apparatus according to claim 7, wherein the power supply suppressing means has a dedicated power supply different from the power supply line.
